(19) United States
(12) Patent Application Publication
(10) Pub. No.: US 2026/0054428 A1
(43) Pub. Date: Feb. 26, 2026

(54) MELAMINE UTENSIL MADE FROM MELAMINE COMPOSITE MATERIAL AND METHOD OF MANUFACTURING THE SAME

(71) Applicant: Sara Rose International INC., NEW TAIPEI CITY (TW)

(72) Inventor: KWO-CHIN CHEN, NEW TAIPEI CITY (TW)

(21) Appl. No.: 18/814,621

(22) Filed: Aug. 26, 2024

(51) Int. Cl. B29C 43/00; A47G 21/00; B29K 61/20; B29K 105/00

(52) U.S. Cl. CPC B29C 43/003; A47G 21/00; B29C 43/006; A47G 2400/10; B29K 2061/20; B29K 2105/251

(57) ABSTRACT

A melamine utensil made from melamine composite material and a method of manufacturing the same are provided. Stir and mix 60-70 weight percentage (wt %) of a primary powder-like melamine material, 20-30 wt % of shards of a secondary melamine material, and 5-15 wt % of melamine resin glazing powder, or 49-59 wt % of the primary powder-like melamine material, 16-26 wt % of shards of the secondary melamine material, 12-22 wt % of pulp, and 6-10 wt % of the melamine resin glazing powder evenly to form a composite material. The composite material is pre-heated and mounted into a mold to produce the melamine utensil by hot pressing. The shards of the secondary melamine material with different shapes, sizes or colors are formed by crushing of the hot-pressed secondary melamine material. During the hot-pressing, the primary melamine material and the melamine resin glazing powder are melted and attached to the secondary melamine material.

### BACKGROUND OF THE INVENTION

The present invention relates to a melamine utensil and a method of manufacturing the same, especially to a melamine utensil made from hot-pressing of a composite material placed in a mold and a method of manufacturing the same. The composite material is formed by a primary powder-like melamine material, shards of a secondary melamine material, and melamine resin glazing powder mixed in a specific weight percentage and stirred evenly.

Refer to a prior art, a melamine vessel having secondary material component and a method of manufacturing the same applied by the same inventor and applicant of the present invention. The related patents include CN200610079114.5 (CN101062722A), CNZL200620113716.3 (CN200978032Y), HK1097993, TWI304384, TWM302333, and US2008/0006960A1 (U.S. Pat. No. 11/480,964). Melamine powdery or granular primary material and broken pieces of hot-pressed melamine secondary material are mixed to form a composite material. Then the composite material is produced into various types of melamine utensils by hot pressing. The above process can replace conventional way of manufacturing melamine utensils which only uses melamine powdery or granular primary materials. Thereby shapes or colors of the broken pieces of the secondary melamine materials are shown clearly on an outer surface of the hot-pressed melamine utensil to provide novel and decorative effects to the melamine utensil. However, melamine is a kind of thermoset resin so that the broken pieces of the melamine secondary material will not melt and integrate with the melamine powdery or granular primary materials during the hot-pressing. Thereby a part of the e broken pieces of the melamine secondary material is exposed directly and even projecting from the outer surface of the hot-pressed melamine utensil. This not only lead to roughness on the outer surface of the melamine utensil but also higher defect rate of the melamine utensil. The striking of the utensil by any hard objects may result in peeling-off or falling-off of the broken pieces of the secondary melamine materials exposed or projecting from the outer surface of the utensil so that the defect rate is increased. Thus growth and development of the market of melamine utensils with secondary materials are limited and consumers'desire to purchase the melamine utensils is reduced.

### SUMMARY OF THE INVENTION

Therefore, it is a primary object of the present invention to provide a melamine utensil made from melamine composite materials and a method of manufacturing the same. Three kinds of materials including a powder-like melamine material, shards of a secondary melamine material, and melamine resin glazing powder are mixed in certain weight percentage evenly to form a composite material. Then the composite material is preheated and placed into a mold to be produced into a melamine utensil by hot-pressing. The shards of the secondary melamine material are shards with different shapes, sizes or colors formed by crushing of the secondary melamine material which has been already hot-pressed. During the hot-pressing, the primary powder-like melamine material and the melamine resin glazing powder are melted by the hot-pressing to form a combination body which is tightly adhered to and covering an outer surface of the respective shards of the secondary melamine materials for protecting the shards of the secondary melamine material from projecting from a surface of the utensil, causing a rough surface of the utensil, and easy to peel and fall off on impact. By the hot-pressing, the shapes and the colors of the shards of the secondary melamine materials are shown on an outer surface of the melamine utensil.

It is another object of the present invention to provide a melamine utensil made from melamine composite materials and a method of manufacturing the same. Four kinds of materials including a powder-like melamine material, shards of a secondary melamine material, pulp, and melamine resin glazing powder are mixed in specific weight percentage evenly to form a composite material. Then the composite material is preheated and placed into a mold to be produced into a melamine utensil by hot-pressing. During the hot-pressing, the primary powder-like melamine material and the melamine resin glazing powder are melted by the hot-pressing to form a combination body which is tightly adhered to and covering an outer surface of the respective shards of the secondary melamine material for protecting the shards of the secondary melamine material from projecting from a surface of the utensil, causing a rough surface of the utensil, and easy to peel and fall off on impact. The pulp used further reduces weight of the utensil formed by the hot-pressing.

In order to achieve the above objects, the three kinds of materials including 60-70 wt % of a primary powder-like melamine material, 20-30 wt % of shards of a secondary melamine material, and 5-15 wt % of melamine resin glazing powder, or the four kinds of materials including 49-59 wt % of the primary powder-like melamine material, 16-26 wt % of shards of the secondary melamine material, 12-22 wt % of pulp, and 6-10 wt % of the melamine resin glazing powder are mixed and stirred evenly to form a composite material. After preheating, the composite material is placed into a mold to be produced into a melamine utensil by hot-pressing. The shards of the secondary melamine material are shards with different shapes, sizes or colors formed by crushing of the secondary melamine material which has been already hot-pressed. The primary powder-like melamine material and the melamine resin glazing powder, or the primary powder-like melamine material, the pulp, and the melamine resin glazing powder are melted by the hot-pressing to form a combination body which is tightly adhered to and covering an outer surface of the respective shards of the secondary melamine material.

Preferably, three kinds of materials including 65 wt % of a primary powder-like melamine material, 25 wt % of shards of a secondary melamine material, and 10 wt % of melamine resin glazing powder, or four kinds of materials including 54 wt % of the primary powder-like melamine material, 21 wt % of shards of the secondary melamine material, 17 wt % of pulp, and 8 wt % of the melamine resin glazing powder are mixed and stirred evenly to form a composite material. Then the composite material is preheated and placed into a mold to be produced into a melamine utensil by hot-pressing. The shards of the secondary melamine material are shards with different shapes, sizes or colors formed by crushing of the secondary melamine material which has been already hot-pressed. The primary powder-like melamine material and the melamine resin glazing powder, or the primary powder-like melamine material, the pulp, and the melamine resin glazing powder are melted by the hot-pressing to form a combination body which is tightly adhered to and covering an outer surface of the respective shards of the secondary melamine material.

### BRIEF DESCRIPTION OF THE DRAWINGS

FIG. 1 is a perspective view of an embodiment according to the present invention;

FIG. 2 is a schematic drawing showing a top view of the embodiment in FIG. 1 according to the present invention;

FIG. 3 is a schematic drawing showing a front view of the embodiment in FIG. 1 according to the present invention;

FIG. 4 is a partial enlarged view of the embodiment in FIG. 3 according to the present invention;

FIG. 5 is a schematic drawing showing manufacturing processes (front-end) of an embodiment according to the present invention;

FIG. 6 is a schematic drawing showing manufacturing processes (back-end) of an embodiment according to the present invention;

FIG. 7 is a perspective view of another embodiment according to the present invention;

FIG. 8 is a schematic drawing showing a top view of the embodiment in FIG. 7 according to the present invention;

FIG. 9 is a schematic drawing showing a front view of the embodiment in FIG. 7 according to the present invention;

FIG. 10 is a partial enlarged view of the embodiment in FIG. 9 according to the present invention;

FIG. 11 is a schematic drawing showing manufacturing processes (front-end) of another embodiment according to the present invention;

FIG. 12 is a schematic drawing showing manufacturing processes (back-end) of another embodiment according to the present invention.

### DETAILED DESCRIPTION OF THE PREFERRED EMBODIMENT

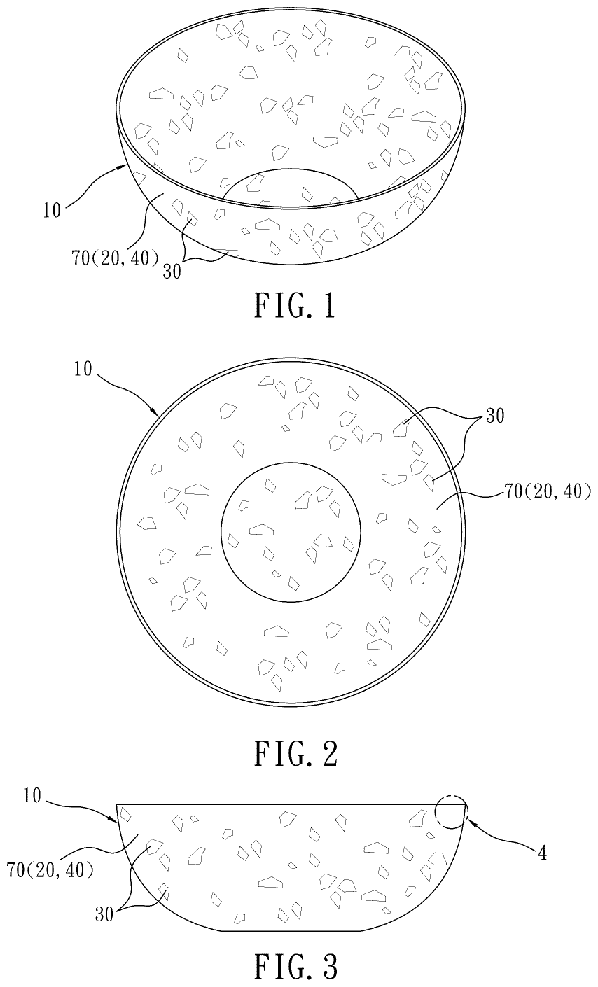

Refer to FIG. 1-6, a melamine utensil 10 according to the present invention is made of a mixture of three kinds of materials including a primary powder-like melamine material 20, shards of a secondary melamine material 30, and melamine resin glazing powder 40 mixed in a specific weight percentage. A weight percentage of the primary powder-like melamine material 20, the shards of the secondary melamine material 30, and the melamine resin glazing powder 40 are respectively 60-70 wt %, 20-30 wt %, and 5-15 wt %. After being mixed, the mixture is stirred evenly to form a composite material 50 (20, 30, 40). After being treated by a pre-heating process, the composite material 50 is mounted into a mold 60 and produced to a melamine utensil 10 by hot pressing. The shards of the secondary melamine material 30 are shards with different shapes, sizes or colors formed by crushing of the secondary melamine material which has been already hot-pressed. By the hot-pressing, the shapes and the colors of the shards of the secondary melamine materials are shown on an outer surface of the melamine utensil.

In a first embodiment, a mixture of 65 wt % of the primary powder-like melamine material 20, 25 wt % of the shards of the secondary melamine material 30, and 10 wt % of the melamine resin glazing powder 40 is stirred evenly to form the composite material 50 which is further used to produce the melamine utensil 10.

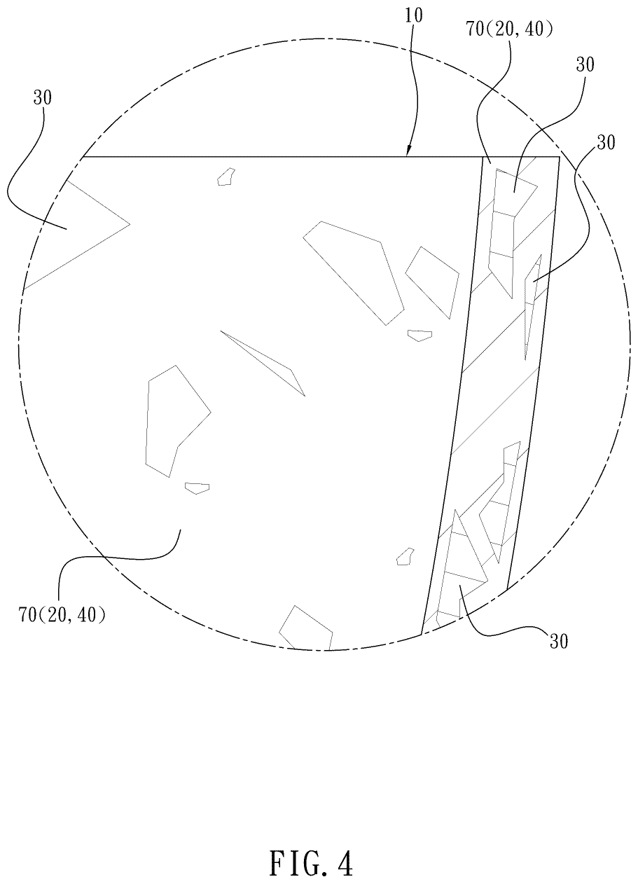

During hot-pressing of the composite material 50 in the mold 60, the primary powder-like melamine material 20 and the melamine resin glazing powder 40 are melted by hot-pressing to form a combination body 70 (20, 40) which is tightly adhered to and covering an outer surface of the respective shards of the secondary melamine material 30, as show in FIG. 4. That means within a structure of the melamine utensil 10 produced, the outer surface of the respective shards of the secondary melamine material 30 is adhered by and covered with at least one layer of the combination 70 (20, 40) which is formed by the primary powder-like melamine material 20 and the melamine resin glazing powder 40 both melted due to hot-pressing. Thereby structural strength of the melamine utensil 10 is enhanced. Therefore, shortcomings of the conventional melamine utensils with secondary materials (such as those revealed in CN200610079114.5, CN ZL200620113716.3, HK1097993, TWI304384, TWM302333, and US2008/0006960A1) such as the surface of the utensil is not smooth and easy to peel and fall off while being struck due to the shards of the secondary melamine material projecting from the surface of the utensil can be overcome.

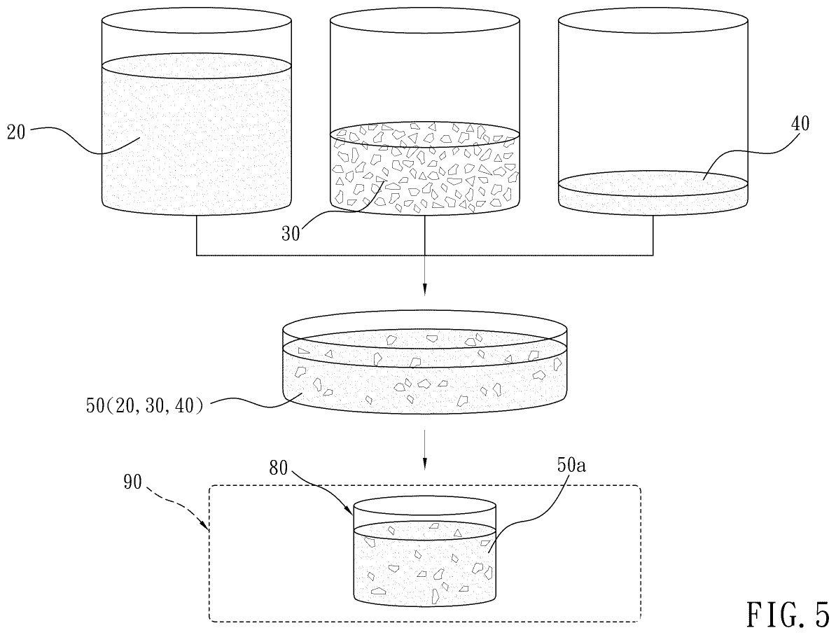

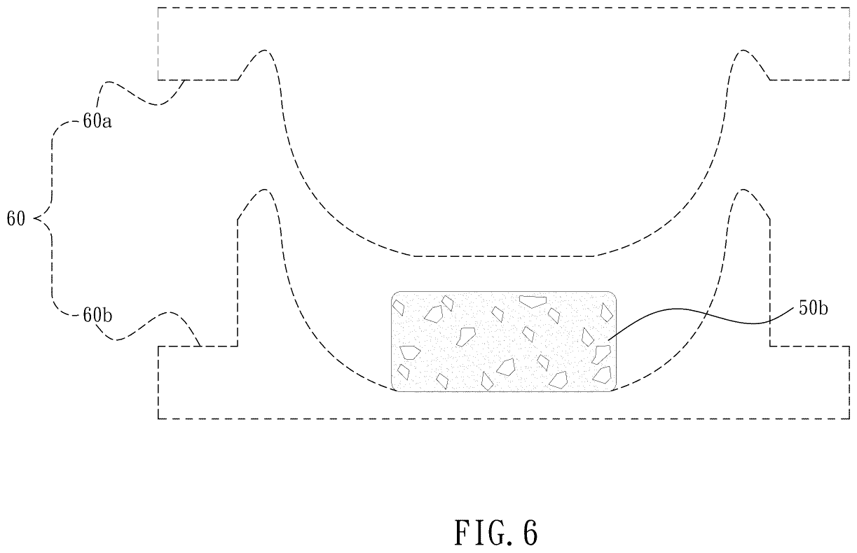

Refer to FIG. 5 and FIG. 6, a method of manufacturing the melamine utensil 10 of the above embodiment includes the following steps.
Step 1: mixing and stirring 60-70 wt % of a primary powder-like melamine material 20, 20-30 wt % of shards of a secondary melamine material 30, and 5-15 wt % of melamine resin glazing powder 40 evenly to form a mixture and then stirring the mixture evenly to form a composite material 50.
Step 2: taking a certain amount of the composite material 50a from the composite material 50 and placing the certain amount of the composite material 50a into a container 80. The certain amount of the composite material 50a is determined according to a volume or a net weight of the melamine utensil 10 going to be manufactured. The container 80 is usually a cylindrical container, as shown in FIG. 5 for mounting the certain amount of the composite material 50a.
Step 3: placing the container 80 with the certain amount of the composite material 50a into a heater 90 (such as an oven) for preheating at a temperature ranging from 40° C. to 45° C. so that the certain amount of the composite material 50a is heated to form a composite soft blank 50b.
Step 4: placing the composite soft blank 50b into a mold 60 of a hot-pressing machine to perform a hot-processing process. The mold 60 generally includes an upper mold 60a and a lower mold 60b combined with each other. A temperature of the upper mold 60a and a temperature of a lower mold 60b are respectively about 175° C. and 165° C.
Step 5: removing a melamine utensil already being hot-pressed from the mold 60 and performing the following operations including cooling, trimming (cutting flash at the edge), etc. to complete production of the melamine utensil 10.

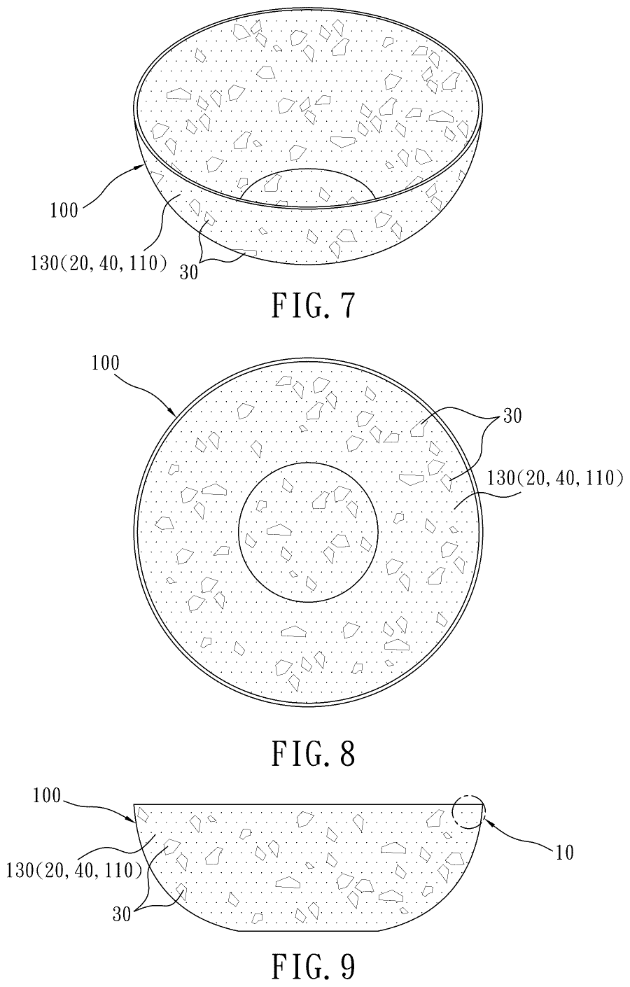

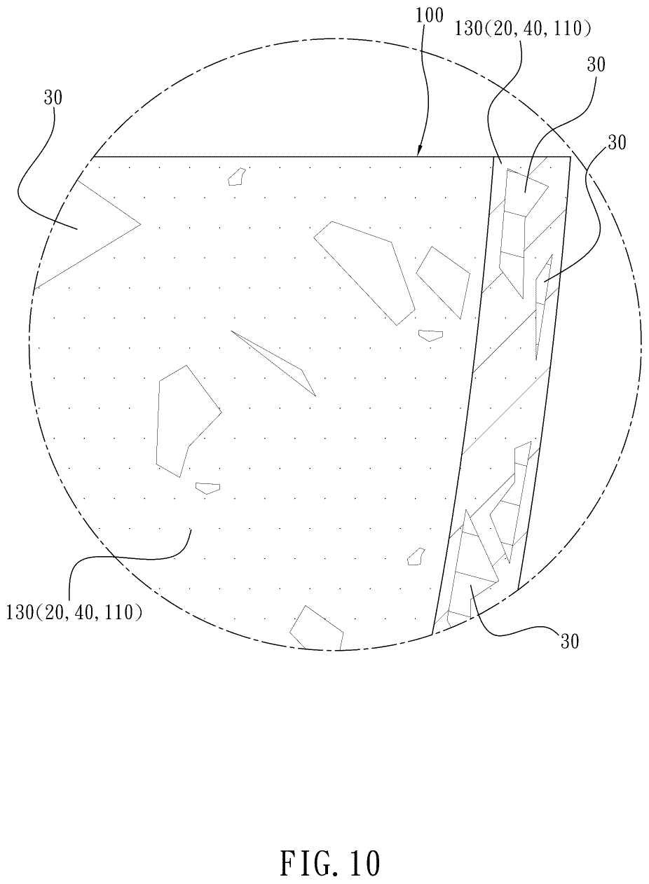

Refer to FIG. 7-12, a structure of a melamine utensil 100 of another embodiment and a method of manufacturing the same are similar to those of the melamine utensil 10 of the above embodiment. The difference between this embodiment and the above one is in that the melamine utensil 100 of this embodiment is made from four kinds of materials including the primary powder-like melamine material 20, the shards of the secondary melamine material 30, pulp 110 and the melamine resin glazing powder 40 mixed in a specific weight percentage. The specific weight percentages of the primary powder-like melamine material 20, the shards of the secondary melamine material 30, the pulp 110, and the melamine resin glazing powder 40 are respectively 49-59 wt %, 16-26 wt %, 12-22 wt %, and 6-10 wt %. After being mixed and stirred evenly, a composite material 120 is obtained. The primary powder-like melamine material 20, the pulp 110, and the melamine resin glazing powder 40 are melt into a combination body 130 (20, 40, 110) by hot-pressing during the hot-pressing process. The combination 130 (20, 40, 110) is firmly attached to an outer surface of the respective shards of the secondary melamine material 30.

In a preferred embodiment, the melamine utensil 100 is further produced by the composite material 120 formed by 54 wt % of the primary powder-like melamine material 20, 21 wt % of the shards of the secondary melamine material 30, 17 wt % of the pulp 110, and 8 wt % of the melamine resin glazing powder 40 which are mixed and stirred evenly.

Moreover, the composite material 120 for the melamine utensil 100 further includes 12-22 wt % of the pulp 110 for further reduction of total weight of the melamine utensil 100.

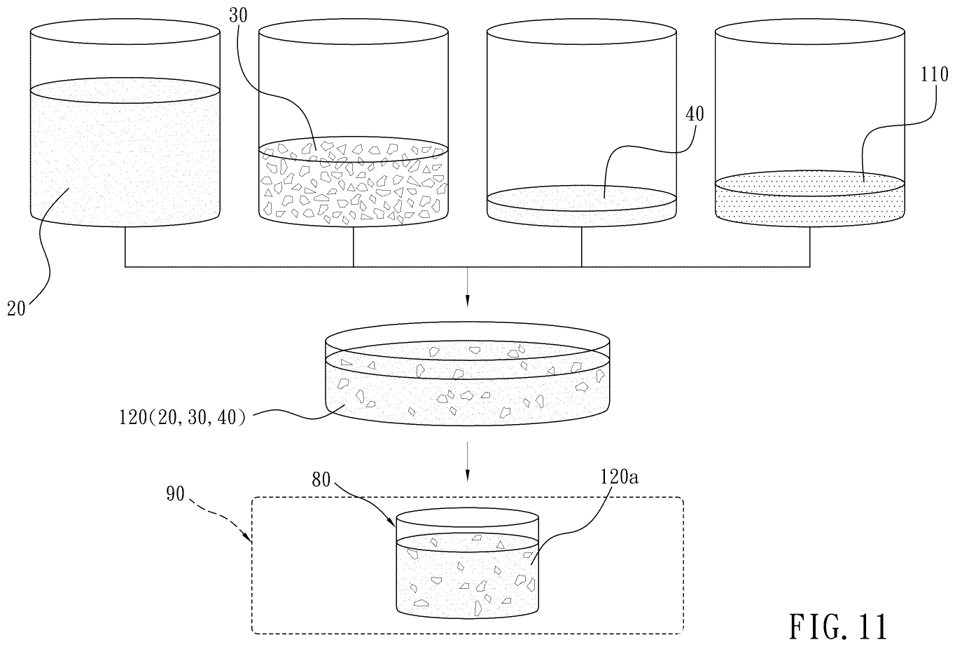

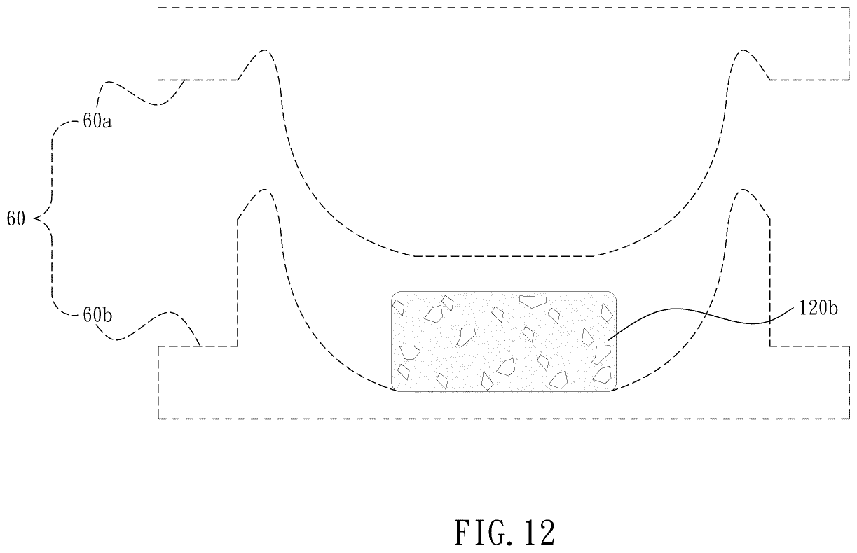

Refer to FIG. 11 and FIG. 12, a method of manufacturing the second embodiment of the melamine utensil 100 includes the following steps.
Step 1: mixing and stirring 60-70 wt % of a primary powder-like melamine material 20, 20-30 wt % of shards of a secondary melamine material 30, 12-22 wt % of pulp 110, and 5-15 wt % of melamine resin glazing powder 40 evenly to form a composite material 120.
Step 2: taking a certain amount of the composite material 120a from the composite material 120 and placing the certain amount of the composite material 120a into a container 80. The certain amount of the composite material 120a is determined according to a volume or a net weight of the melamine utensil 100 going to be manufactured. The container 80 is usually a cylindrical container, as shown in FIG. 11 for mounting the certain amount of the composite material 120a.
Step 3: placing the container 80 with the certain amount of the composite material 120a into a heater 90 (such as an oven) for preheating at a temperature ranging from 40° C. to 45° C. so that the certain amount of the composite material 120a is heated to form a composite soft blank 120b.
Step 4: mounting the composite soft blank 120b into a mold 60 of a hot-pressing machine to perform a hot-processing process. The mold 60 generally includes an upper mold 60a and a lower mold 60b combined with each other. A temperature of the upper mold 60a and a temperature of a lower mold 60b are respectively about 175° C. and 165° C.
Step 5: removing a melamine utensil already being hot-pressed from the mold 60 and performing the following operations including cooling, trimming (cutting flash at the edge), etc. to complete production of the melamine utensil 100.

Compared with the melamine utensil available now, the melamine utensils 10, 100 according to the present invention have the following advantages.
(1) The melamine utensils 10, 100 of the present invention are produced by three kinds of materials including a powder-like melamine material 20, shards of a secondary melamine material 30, and melamine resin glazing powder 40 (the first embodiment) or the primary powder-like melamine material 20, the shards of the secondary melamine material 30, pulp 110 and the melamine resin glazing powder 40 (the second embodiment) mixed in certain weight percentage evenly to form the composite material 50, 120. During hot-pressing of the composite material 50, 120 in the mold 60, the primary powder-like melamine material 20, the shards of the secondary melamine material 30, and the melamine resin glazing powder 40, or the primary powder-like melamine material 20, the shards of the secondary melamine material 30, pulp 110 and the melamine resin glazing powder 40 are melted by the hot-pressing to form a combination body 70 (20, 40) or 130 (20, 40, 110) which is tightly adhered to and covering an outer surface of the respective shards of the secondary melamine material 30. Thereby structural strength of the melamine utensils 10, 100 is increased and the shortcomings of the conventional melamine utensils or melamine utensils available now such as the surface of the utensil is not smooth and easy to peel and fall off while being struck due to the shards of the secondary melamine material projecting from the surface of the utensil can be overcome. Therefore, the market competitiveness of the products is improved.
(2) The composite material 120 of the melamine utensil 100 of the second embodiment further includes 12-22 wt % pulp 11p so that a weight of the melamine utensil 100 is further reduced, this is eco-friendly and the market competitiveness of the product is further increased.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A melamine utensil made from a melamine composite material comprising a powder-like melamine material, shards of a secondary melamine material, and melamine resin glazing powder mixed in certain weight percentage; the melamine composite material being produced into the melamine utensil by a hot-pressing process; the melamine utensil having a combination body and a plurality of the shards of a secondary melamine material;
wherein the combination is formed by the primary powder-like melamine material and the melamine resin glazing powder of the melamine composite material both melted by the hot-pressing process; the combination is located among the respective shards of the secondary melamine material and tightly adhered to and covering an outer surface of the respective shards of the secondary melamine material by the hot-pressing process; wherein the shards of the secondary melamine material are having different shapes, sizes or colors and formed by crushing of hot-pressed secondary melamine material; the shapes and the colors of the shards of the secondary melamine material are shown on an outer surface of the melamine utensil by the hot-pressing process.

2. The melamine utensil as claimed in claim 1, wherein the melamine composite material is formed by even mixing and stirring of 60-70 wt % of a primary powder-like melamine material, 20-30 wt % of shards of a secondary melamine material, and 5-15 wt % of melamine resin glazing powder.

3. The melamine utensil as claimed in claim 2, wherein the melamine composite material is formed by even mixing and stirring of 65 wt % of a primary powder-like melamine material, 25 wt % of shards of a secondary melamine material, and 10 wt % of melamine resin glazing powder.

4. A method of manufacturing a melamine utensil made from a melamine composite material comprising the steps of:
Step 1: mixing and stirring 60-70 wt % of a primary powder-like melamine material, 20-30 wt % of shards of a secondary melamine material, and 5-15 wt % of melamine resin glazing powder evenly to form the melamine composite material;
Step 2: taking a certain amount of the melamine composite material from the melamine composite material and placing the certain amount of the melamine composite material into a container; wherein the certain amount of the melamine composite material is determined according to a volume or a net weight of the melamine utensil going to be manufactured; wherein the container is a cylindrical container for mounting the certain amount of the melamine composite material therein;
Step 3: placing the container with the certain amount of the melamine composite material into a heater for preheating so that the certain amount of the melamine composite material is heated to form a composite soft blank;
Step 4: placing the composite soft blank into a mold of a hot-pressing machine to perform a hot-processing process; and
Step 5: removing a melamine utensil already being hot-pressed from the mold to complete manufacturing of the melamine utensil after cooling and trimming.

5. A melamine utensil made from a melamine composite material comprising a powder-like melamine material, shards of a secondary melamine material, pulp, and melamine resin glazing powder mixed in certain weight percentage to form the melamine composite material which is further produced into the melamine utensil by a hot-pressing process; the melamine utensil having a combination body and a plurality of the shards of a secondary melamine material;
wherein the combination is formed by the primary powder-like melamine material, the pulp, and the melamine resin glazing powder of the melamine composite material all melted by the hot-pressing process; the combination is located among the respective shards of the secondary melamine material and tightly adhered to and covering an outer surface of the respective shards of the secondary melamine material by the hot pressing process; wherein the shards of the secondary melamine material are having different shapes, sizes or colors and formed by crushing of hot-pressed secondary melamine material; the shapes and the colors of the shards of the secondary melamine material are shown on an outer surface of the melamine utensil by the hot-pressing process.

6. The melamine utensil as claimed in claim 5, wherein the melamine composite material is formed by even mixing and stirring of 49-59 wt % of a primary powder-like melamine material, 16-26 wt % of shards of a secondary melamine material, 12-22 wt % of pulp, and 6-10 wt % of melamine resin glazing powder.

7. The melamine utensil as claimed in claim 6, wherein the melamine composite material is further formed by even mixing and stirring of 54 wt % of a primary powder-like melamine material, 21 wt % of shards of a secondary melamine material, 17 wt % of pulp, and 8 wt % of melamine resin glazing powder.

8. A method of manufacturing a melamine utensil made from a melamine composite material comprising the steps of:
Step 1: mixing and stirring 60-70 wt % of a primary powder-like melamine material, 20-30 wt % of shards of a secondary melamine material, 12-22 wt % of pulp, and 5-15 wt % of melamine resin glazing powder evenly to form the melamine composite material;
Step 2: taking a certain amount of the melamine composite material from the melamine composite material and placing the certain amount of the melamine composite material into a container; wherein the certain amount of the melamine composite material is determined according to a volume or a net weight of the melamine utensil going to be manufactured; wherein the container is a cylindrical container for mounting the certain amount of the melamine composite material therein;
Step 3: placing the container with the certain amount of the melamine composite material into a heater for preheating so that the certain amount of the melamine composite material is heated to form a composite soft blank;
Step 4: placing the composite soft blank into a mold of a hot-pressing machine to perform a hot-processing process; and
Step 5: removing a melamine utensil already being hot-pressed from the mold to complete manufacturing of the melamine utensil after cooling and trimming.
